(19) United States
(12) Patent Application Publication
(10) Pub. No.: US 2009/0241653 A1
(43) Pub. Date: Oct. 1, 2009

(54) EXHAUST GAS SENSING SYSTEM AND METHODS FOR SENSING CONCENTRATIONS OF EXHAUST GAS CONSTITUENTS

(76) Inventors: Da Yu Wang, Troy, MI (US); David D. Cabush, Kokomo, IN (US)

Correspondence Address: DELPHI TECHNOLOGIES, INC., M/C 480-410-202, PO BOX 5052, TROY, MI, 48007, US

(21) Appl. No.: 12/056,789

(22) Filed: Mar. 27, 2008

(51) Int. Cl. G01M 15/10

(52) U.S. Cl. 73/114.71; 702/50

(57) ABSTRACT

Exhaust gas sensing system and methods for sensing concentrations of exhaust gas constituents are provided. The exhaust gas sensing system includes a NOₓ sensing cell configured to generate a voltage in response to exhaust gases communicating with the NOₓ sensing cell. The exhaust gas sensing system further includes a temperature sensor configured to generate a signal indicative of a temperature of the exhaust gases. The exhaust gas sensing system further includes a controller configured to receive the voltage from the NOₓ sensing cell and to determine a first NOₓ value based on the voltage. The controller is further configured to receive the signal from the temperature sensor and to determine a temperature value based on the signal. The controller is further configured to determine a NO₂ concentration value indicative of an amount of NO₂ in the exhaust gases based on the first NOₓ value and the temperature value, and to store the NO₂ concentration value in a memory device. The controller is further configured to determine a NOₓ concentration value indicative of an amount of NOₓ in the exhaust gases based on the NO₂ concentration value and the temperature value, and to store the NOₓ concentration value in the memory device.

### BACKGROUND

A NOₓ sensor has been developed that detects NOₓ concentrations. However, the NOₓ sensor is not capable of accurately determining nitrogen dioxide (NO₂) and nitrogen monoxide (NO) concentrations. Further, the NOₓ sensor is not able to accurately determine NOₓ, NO₂ and NO concentrations in exhaust gases when the exhaust gases have ammonia (NH₃) therein.

### SUMMARY OF THE INVENTION

An exhaust gas sensing system in accordance with an exemplary embodiment is provided. The exhaust gas sensing system includes a NOₓ sensing cell configured to generate a voltage in response to exhaust gases communicating with the NOₓ sensing cell. The exhaust gas sensing system further includes a temperature sensor configured to generate a signal indicative of a temperature of the exhaust gases. The exhaust gas sensing system further includes a controller configured to receive the voltage from the NOₓ sensing cell and to determine a first NOₓ value based on the voltage. The controller is further configured to receive the signal from the temperature sensor and to determine a temperature value based on the signal. The controller is further configured to determine a NO₂ concentration value indicative of an amount of NO₂ in the exhaust gases based on the first NOₓ value and the temperature value, and to store the NO₂ concentration value in a memory device. The controller is further configured to determine a NOₓ concentration value indicative of an amount of NOₓ in the exhaust gases based on the NO₂ concentration value and the temperature value, and to store the NOₓ concentration value in the memory device.

A method for sensing exhaust gases, utilizing an exhaust gas sensing system, in accordance with another exemplary embodiment is provided. The system has a NOₓ sensing cell, a temperature sensor, and a controller. The method includes generating a voltage in response to the exhaust gases communicating with the NOₓ sensing cell, utilizing the NOₓ sensing cell. The method further includes generating a signal indicative of a temperature of the exhaust gases, utilizing a temperature sensor. The method further includes determining a first NOₓ value based on the voltage, utilizing the controller. The method further includes determining a temperature value based on the signal, utilizing the controller. The method further includes determining a NO₂ concentration value indicative of an amount of NO₂ in the exhaust gases based on the first NOₓ value and the temperature value, and storing the NO₂ concentration value in a memory device, utilizing the controller. The method further includes determining a NOₓ concentration value indicative of an amount of NOₓ in the exhaust gases based on the NO₂ concentration value and the temperature value, and storing the NOₓ concentration value in the memory device, utilizing the controller.

An exhaust gas sensing system in accordance with another exemplary embodiment is provided. The exhaust gas sensing system includes a NOₓ sensing cell configured to generate a voltage in response to exhaust gases communicating with the NOₓ sensing cell. The exhaust gas sensing system further includes a temperature sensor configured to generate a signal indicative of a temperature of the exhaust gases. The exhaust gas sensing system further includes a controller configured to receive the voltage from the NOₓ sensing cell and to determine a first NOₓ value based on the voltage. The controller is further configured to receive the signal from the temperature sensor and to determine a temperature value based on the signal. The controller is further configured to determine an NO concentration value indicative of an amount of NO in the exhaust gases based on the first NOₓ value and a constant value, and to store the NO concentration value in a memory device. The controller is further configured to set a NOₓ concentration value indicative of an amount of NOₓ in the exhaust gases equal to the NO concentration value, and to store the NOₓ concentration value in the memory device.

A method for sensing exhaust gases, utilizing an exhaust gas sensing system, in accordance with another exemplary embodiment is provided. The system has a NOₓ sensing cell, a temperature sensor, and a controller. The method includes generating a voltage in response to the exhaust gases communicating with the NOₓ sensing cell, utilizing the NOₓ sensing cell. The method further includes generating a signal indicative of a temperature of the exhaust gases, utilizing a temperature sensor. The method further includes determining a first NOₓ value based on the voltage, utilizing the controller. The method further includes determining a temperature value based on the signal, utilizing the controller. The method further includes determining an NO concentration value indicative of an amount of NO in the exhaust gases based on the first NOₓ value and a constant value, and storing the NO concentration value in a memory device, utilizing the controller. The method further includes determining a NOₓ concentration value indicative of an amount of NOₓ in the exhaust gases equal to the NO concentration value, and storing the NOₓ concentration value in the memory device, utilizing the controller.

An exhaust gas sensing system in accordance with another exemplary embodiment is provided. The exhaust gas sensing system includes a NOₓ sensing cell configured to generate a first voltage in response to exhaust gases communicating with the NOₓ sensing cell. The exhaust gas sensing system further includes a NH₃ sensing cell configured to generate a second voltage in response to the exhaust gases communicating with the NH₃ sensing cell. The exhaust gas sensing system further includes a temperature sensor configured to generate a signal indicative of a temperature of the exhaust gases. The exhaust gas sensing system further includes a controller configured to receive the first voltage from the NOₓ sensing cell and to determine a first NOₓ value based on the first voltage. The controller is further configured to receive the second voltage from the NH₃ sensing cell and to determine a first NH₃ value based on the second voltage. The controller is further configured to receive the signal and to determine a temperature value based on the signal. The controller is further configured to determine an NH₃ concentration value based on the first NOₓ value and the first NH₃ value. The controller is further configured to determine a NO₂ concentration value indicative of an amount of NO₂ in the exhaust gases based on the first NOₓ value, the NH₃ concentration value, and the temperature value, and to store the NO₂ concentration value in a memory device. The controller is further configured to determine a NOₓ concentration value based on the NO₂ concentration value and the temperature value, and to store the NOₓ concentration value in the memory device.

A method for sensing exhaust gases, utilizing an exhaust gas sensing system, in accordance with another exemplary embodiment is provided. The system has a NOₓ sensing cell, a NH₃ sensing cell, a temperature sensor, and a controller. The method includes generating a first voltage in response to exhaust gases communicating with the NOₓ sensing cell, utilizing the NOₓ sensing cell. The method further includes generating a second voltage in response to the exhaust gases communicating with the NH₃ sensing cell, utilizing the NH₃ sensing cell. The method further includes generating a signal indicative of a temperature of the exhaust gases, utilizing the temperature sensor. The method further includes determining a first NOₓ value based on the first voltage, utilizing the controller. The method further includes determining a first NH₃ value based on the second voltage, utilizing the controller. The method further includes determining a temperature value based on the signal, utilizing the controller. The method further includes determining an NH₃ concentration value based on the first NOₓ value and the first NH₃ value, utilizing the controller. The method further includes determining a NO₂ concentration value indicative of an amount of NO₂ in the exhaust gases based on the first NOₓ value, the NH₃ concentration value, and the temperature value, and storing the NO₂ concentration value in a memory device, utilizing the controller. The method further includes determining a NOₓ concentration value based on the NO₂ concentration value and the temperature value, and storing the NOₓ concentration value in the memory device, utilizing the controller.

### BRIEF DESCRIPTION OF THE DRAWINGS

FIG. 1 is a schematic of a vehicle having an exhaust gas sensing system in accordance with an exemplary embodiment;

FIG. 2 is an exploded schematic of a NH₃/NOₓ sensor utilized in the exhaust gas sensing system of FIG. 1;

FIGS. 3-5 are flowcharts of a method for sensing exhaust gases, utilizing the NH₃/NOₓ sensor of FIG. 2, in accordance with another exemplary embodiment;

FIG. 6 is a graph of exemplary signal curves indicating temperature, NOₓ, and an exhaust flow rate over a time interval;

FIG. 7 is a graph of exemplary curves indicating NOₓ concentrations and NO₂ concentrations over a similar time interval as FIG. 6;

FIG. 8 is an exploded schematic of another NH₃/NOₓ sensor utilized in the exhaust gas sensing system of FIG. 1;

FIGS. 9-11 are flowcharts of a method for sensing exhaust gases, utilizing the NH₃/NOₓ sensor of FIG. 8, in accordance with another exemplary embodiment;

FIG. 12 is a graph of exemplary signal curves indicating temperature NOₓ, NH₃, and an exhaust flow rate over a time interval;

FIG. 13 is a graph of exemplary signal curves indicating NH₃ concentrations over a similar time interval as FIG. 12;

FIG. 14 is a graph of exemplary signal curves indicating NO₂ concentrations over a similar time interval as FIG. 12; and

FIG. 15 is a graph of exemplary signal curves indicating NOₓ concentrations over a similar time interval as FIG. 12.

### DETAILED DESCRIPTION OF EXEMPLARY EMBODIMENTS

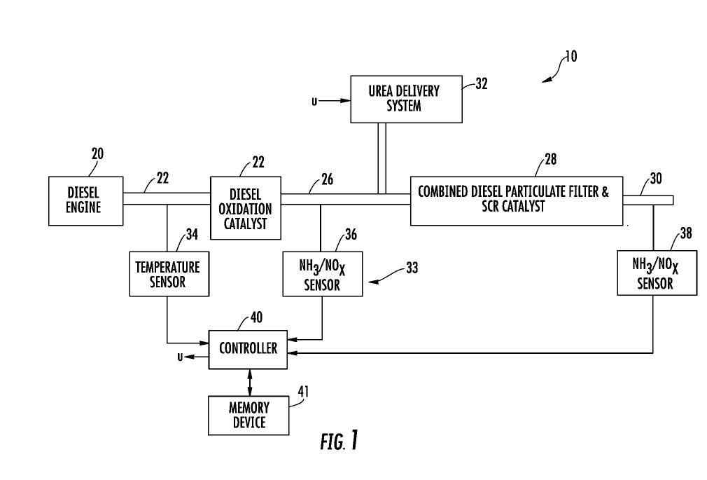

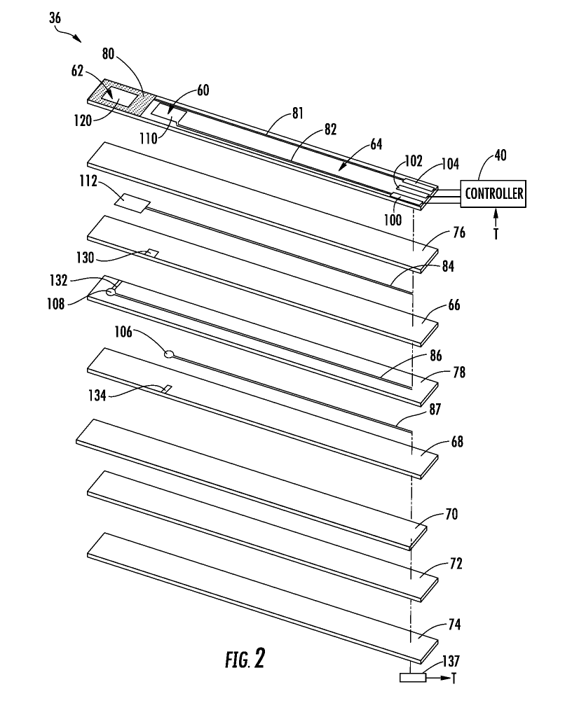

Referring to FIG. 1, a vehicle 10 is illustrated. The vehicle 10 has a diesel engine 20, an exhaust pipe 22, a diesel oxidation catalyst 24, a combined diesel particulate filter and SCR catalyst 28, an exhaust pipe 30, a urea delivery system 32, and an exhaust gas sensing system 33. An advantage of the exhaust gas sensing system 33 is that the system 33 can accurately detect NOₓ concentrations, NO₂ concentrations, NO concentrations, and NH₃ concentrations in exhaust gases emitted from the diesel engine 20.

The diesel engine 20 generates exhaust gases that are routed through the exhaust pipe 22 to the diesel oxidation catalyst 24. The diesel oxidation catalyst 24 converts CO in the exhaust gases to CO₂. Thereafter, the exhaust gases flow from the diesel oxidation catalyst 24 through the exhaust pipe 26 to the combined diesel particulate filter and SCR catalyst 28. The diesel particulate filter and SCR catalyst 28 traps particulates in the exhaust gases and reduces CO₂ and NO₂ in the exhaust gases utilizing urea from the urea delivery system 32. Thereafter, the exhaust gases flow from the diesel particulate filter and SCR catalyst 28 through the exhaust pipe 30 to ambient atmosphere.

The exhaust gas sensing system 33 is provided to determine NOₓ concentrations, NO₂ concentrations, NO concentrations and NH₃ concentrations in exhaust gases from the diesel engine 22. The exhaust gas sensing system 33 has a temperature sensor 34, NH₃/NOₓ sensors 36, 38, and a controller 40.

The temperature sensor 34 is operably coupled to the exhaust pipe 22. The temperature sensor 34 is configured to generate a signal indicative of a temperature of exhaust gases emitted from the diesel engine 20, which is received by the controller 40.

The NH₃/NOₓ sensor 36 is provided to generate a voltage indicative of a NOₓ concentration in exhaust gases downstream of the diesel oxidation catalyst 26. It should also be noted that the NH₃/NOₓ sensor 36 could also generate a voltage indicative of a NH₃ concentration in exhaust gases downstream of the diesel oxidation catalyst 26 in exhaust pipe 26, although the NH₃ concentration in exhaust pipe 24 is not needed in this embodiment. The NH₃/NOₓ sensor 36 includes a NOₓ sensing cell 60, a NH₃ sensing cell 62, insulating layers 64, 66, 68, 70, 72, 74, an electrolyte layer 76, an active layer 78, a current collector 80, electrical leads 81, 82, 84, 86, 87, contact pads 100, 102, 104, electrodes 106, 108, and a contact pad 137.

The NOₓ sensing cell 60 is provided to generate a voltage indicative of a NOₓ concentration in exhaust gases communicating with the NOₓ sensing cell 60. The NOₓ sensing cell 60 includes a NOₓ sensing electrode 110, a reference electrode 112, and the electrolyte layer 76. The NOₓ electrode 100 is disposed on the top surface of the insulating layer 64 and is electrically coupled via the electrical lead 82 to the contact pad 100. The electrolyte layer 76 is disposed between a bottom surface of the insulating layer 64 and a top surface of the insulating layer 66. The reference electrode 112 is disposed on a top surface of the insulating layer 66, which is disposed adjacent a bottom surface of the electrolyte layer 76. The reference electrode 112 is electrically coupled via the electrical lead 84 to the contact pad 102. The general function of the NOₓ sensing electrode 110 include, NOₓ sensing capability (e.g., catalyzing NOₓ gas to produce an emf), electrical conducting capability (conducting electrical current produced by the emf), and gas diffusion capability (providing sufficient open porosity so that gas can diffuse throughout the electrode and to the interface region of the electrode and electrolyte). The NOₓ sensing electrode 110 can be constructed from oxides of ytterbium, chromium, europium, erbium, zinc, neodymium, iron, magnesium, gadolinium, terbium, chromium, as well as combinations comprising at least one of the foregoing, such as YbCrO₃, LaCrO₃, ErCrO₃, EuCrO₃, SmCrO₃, HoCrO₃, GdCrO₃, NdCrO₃, TbCrO₃, ZnFe₂O₄, MgFe₂O₄, and ZnCr₂O₄, as well as combinations comprising at least one of the foregoing. Further, the NOx sensing electrode 110 can comprise dopants that enhance the material(s)' NOx sensitivity and selectivity and electrical conductivity at the operating temperature. These dopants can include one or more of the following elements: Ba (barium), Ti (titanium), Ta (tantalum), K (potassium), Ca (calcium), Sr (strontium), V (vanadium), Ag (silver), Cd (cadmium), Pb (lead), W (tungsten), Sn (tin), Sm (samarium), Eu (europium), Er (Erbium), Mn (manganese), Ni (nickel), Zn (zinc), Na (sodium), Zr (zirconium), Nb (niobium), Co (cobalt), Mg (magnesium), Rh (rhodium), Nd (neodymium), Gd (gadolinium), and Ho (holmium), as well as combinations comprising at least one of the foregoing dopants.

The NH₃ sensing cell 62 is provided to generate a voltage indicative of a NH₃ concentration in exhaust gases communicating with the NH₃ sensing cell 62. The NH₃ sensing cell 62 includes a NH₃ sensing electrode 120, the reference electrode 112, and the electrolyte layer 76. The NH₃ sensing electrode 120 is disposed on a current collector 80 which is further disposed on the portion of the top surface of the insulating layer 64. The NH₃ sensing electrode 120 is electrically coupled via the electrical lead 82 the contact pad 104. The general function of the NH₃ sensing electrode 120 includes NH₃ sensing capability (e.g., catalyzing NH₃ gas to produce an electromotive force (emf)), electrical conducting capability (conducting electrical current produced by the emf), and gas diffusion capability (providing sufficient open porosity so that gas can diffuse throughout the electrode and to the interface region of the NH₃ sensing electrode 120 and the electrolyte layer 76). The NH₃ sensing electrode 120 can be constructed from first oxide compounds of vanadium (V), tungsten (W), and molybdenum (Mo), as well as combinations comprising at least one of the foregoing, which can be doped with second oxide components, which can increase the electrical conductivity or enhance the NH₃ sensing sensitivity and/or NH₃ sensing selectivity to the first oxide components. Exemplary first components include the ternary vanadate compounds such as bismuth vanadium oxide (BiVO₄), copper vanadium oxide (Cu₂(VO₃)₂), ternary oxides of tungsten, and/or ternary molybdenum (MoO₃), as well as combinations comprising at least one of the foregoing. Exemplary second component metals include oxides such as alkali oxides, alkali earth oxides, transition metal oxides, rare earth oxides, and oxides such as SiO₂, ZnO, SnO, PbO, TiO₂, In₂O₃, Ga₂O₃, Al₂O₃, GeO, and Bi₂O₃, as well as combinations comprising at least one of the foregoing. The NH₃ electrode material can also include traditional oxide electrolyte materials such as zirconia, doped zirconia, ceria, doped ceria, or SiO₂, Al₂O₃ and the like, e.g., to form porosity and increase the contact area between the NH₃ electrode material and the electrolyte. Additives of low soft point glass frit materials can be added to the electrode materials as binders to bind the electrode materials to the surface of the electrolyte. Further examples of NH₃ sensing electrode materials can be found in U.S. patent Ser. No. 10/734,018, to Wang et al., and commonly assigned herewith.

The insulating layer 66 is disposed between the electrolyte layer 76 and the active layer 78. The insulating layer 66 includes an inlet 130 extending therethrough for communicating exhaust gases to the reference electrode 112. The insulating layer 66 can be constructed from a dielectric material such as alumina.

The active layer 78 is disposed between the insulating layer 66 and the insulating layer 68. The electrode 108 is disposed on the top surface of the active layer 78 and is disposed adjacent an inlet 132 extending through the active layer 78. The inlet 132 is in fluid communication with the inlet 130 in the insulating layer 66. The electrode 108 is electrically coupled to an electrical lead 86 which is further electrically coupled to the contact pad 102. The active layer 78 can be constructed from a dielectric material such as alumina.

The insulating layer 68 is disposed between the active layer 78 and the insulating layer 70. The insulating layer 68 can be constructed from a dielectric material such as alumina. The insulating layer 68 has an inlet 134 extending therethrough that is in fluid communication with the inlet 132 of the active layer 78. The electrode 106 is disposed on a top surface of the insulating layer 68 and is electrically coupled via the electrical lead 87 to the contact pad 137. The electrode 106 generates a signal (T) indicative of a temperature of exhaust gases communicating with the NH₃/NOₓ sensor 36 that is received by the controller 40.

The insulating layer 70 is disposed between the insulating layer 68 and the insulating layer 72. The insulating layer 70 can be constructed from a dielectric material such as alumina.

The insulating layer 72 is disposed between the insulating layer 68 and the insulating layer 74. The insulating layers 72 and 74 can be constructed from a dielectric material such as alumina.

The contact pads 100, 102, 104 are disposed on the top surface of the insulating layer 64. A voltage between the contact pads 100, 102 is indicative of a NOₓ concentration in exhaust gases communicating with the sensor 36. A voltage between the contact pads 104 and 102 is indicative of a NH₃ concentration in exhaust gases communicating with the sensor 36.

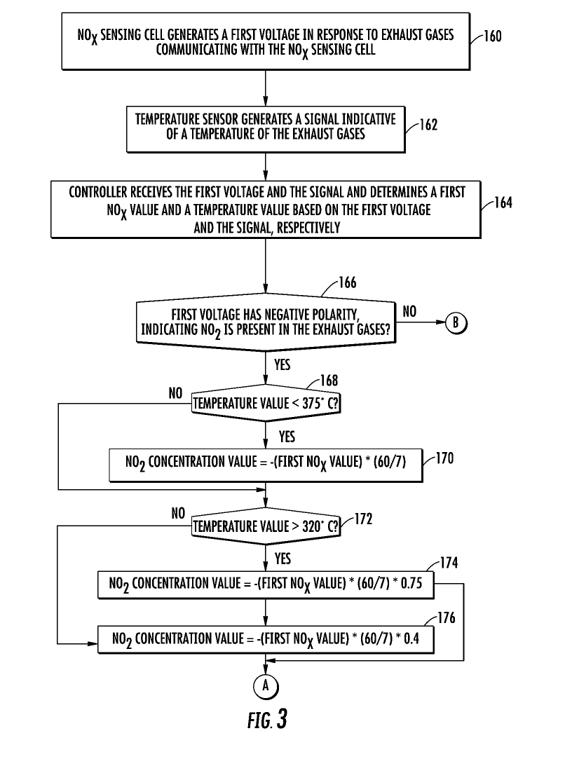

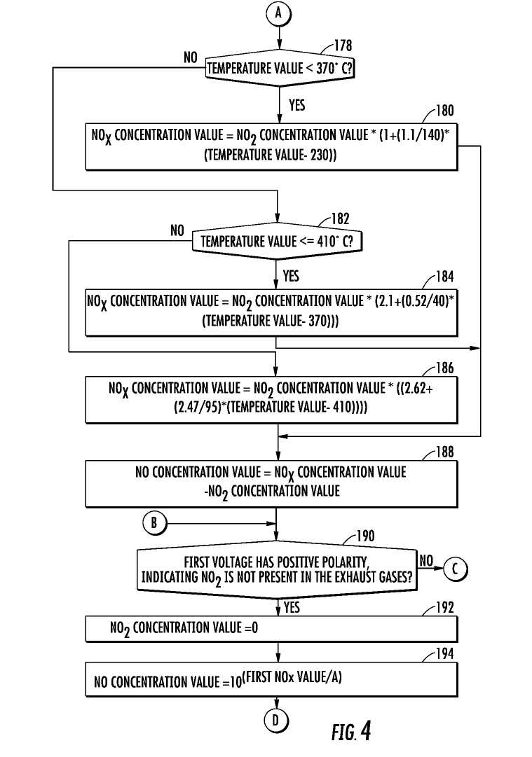

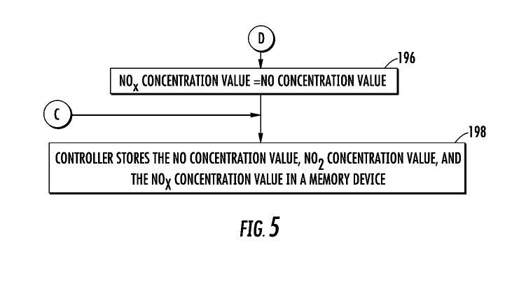

Referring to FIGS. 3-5, a flowchart of a method for sensing exhaust gas constituents utilizing the exhaust gas sensing system 33 will now be explained.

At step 160, the NOₓ sensing cell 60 generates a first voltage in response to exhaust gases communicating with the NOₓ sensing cell 60.

At step 162, the temperature sensor 34 generates a signal indicative of a temperature of the exhaust gases.

At step 164, the controller 40 receives the first voltage and the signal and determines a first NOₓ value and a temperature value based on the first voltage and the signal, respectively.

At step 166, the controller 40 makes a determination as to whether a first voltage has a negative polarity, indicating NO₂ is present in the exhaust gases. If the value of step 166 equals “yes”, the method advances to step 168. Otherwise, the method advances to step 190.

At step 168, the controller 40 makes a determination as to whether the temperature value is less than 375° C. If the value of step 168 equals “yes”, the method advances to step 170. Otherwise, the method advances to step 172.

At step 170, the controller 40 calculates a NO₂ concentration value utilizing the following equation: NO₂ concentration value=−(first NOₓ value)*(60/7). After step 170, the method advances to step 172.

At step 172, the controller 40 makes a determination as to whether the temperature value is less than 320° C. If the value of step 172 equals “yes”, the method advances to step 174. Otherwise, the method advances to step 176.

At step 174, the controller 40 calculates the NO₂ concentration value utilizing the following equation: NO₂ concentration value=−(first NOₓ value)*(60/7)*0.75. After step 174, the method advances to step 178.

At step 176, the controller 40 calculates the NO₂ concentration value utilizing the following equation: NO₂ concentration value=−(first NOₓ value)*(60/7)*0.4. After step 176, the method advances to step 178.

At step 178, the controller 40 makes a determination as to whether the temperature value is less than 370° C. If the value of step 178 equals “yes”, the method advances to step 180. Otherwise, the method advances to step 182.

At step 180, the controller 40 calculates the NOₓ concentration value utilizing the following equation: NOₓ concentration value=NO₂ concentration value*(1+(1.1/140)*(temperature value−230)). After step 180, the method advances to step 188.

At step 182, the controller 40 makes a determination as to whether the temperature value is less than or equal to 410° C. If the value of step 182 equals “yes”, the method advances to step 184. Otherwise, the method advances to step 186.

At step 184, the controller 40 calculates in the NOₓ concentration value utilizing the following equation: NOₓ concentration value=NO₂ concentration value*(2.1+(0.52/40)*(temperature value−370))). After step 184, the method advances to step 188.

At step 186, the controller 40 calculates in the NOₓ concentration value utilizing the following equation: NOₓ concentration value=NO₂ concentration value*((2.62+(2.47/95)*(temperature value−410)))). After step 186, the method advances to step 188.

At step 188, the controller 40 calculates a NO concentration value utilizing the following equation: NO concentration value=NOₓ concentration value —NO₂ concentration value. After step 188, the method advances to step 190.

At step 190, the controller 40 makes a determination as to whether the first voltage has a positive polarity, indicating NO₂ is not present in the exhaust gases. If the value of step 190 equals “yes”, the method advances to step 192. Otherwise, the method advances to step 198.

At step 192, the controller 40 calculates the NO₂ concentration value utilizing the following equation: NO₂ concentration value=0. After step 192, the method advances to step 194.

At step 194, the controller 40 calculates the NO concentration value utilizing the following equation: NO concentration value=10^{(first NOx value/A)}. After step 194, the method advances to step 196.

At step 196, the controller 40 calculates the NOₓ concentration value utilizing the following equation: NOₓ concentration value=NO concentration value. After step 196, the method advances to step 198.

At step 198, the controller 40 stores the NO concentration value, NO₂ concentration value, the NOₓ concentration value in the memory device 41.

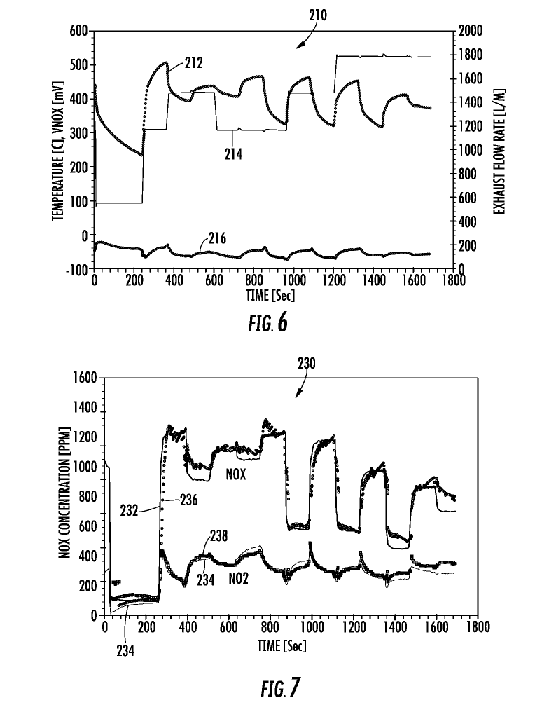

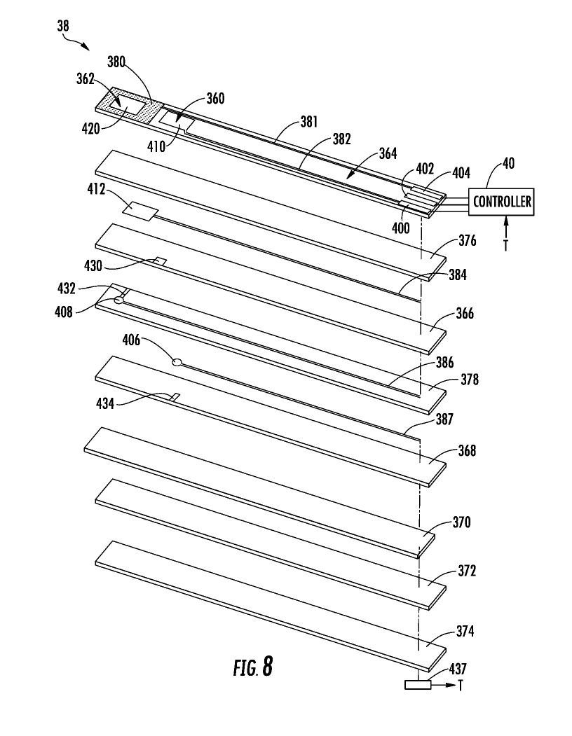

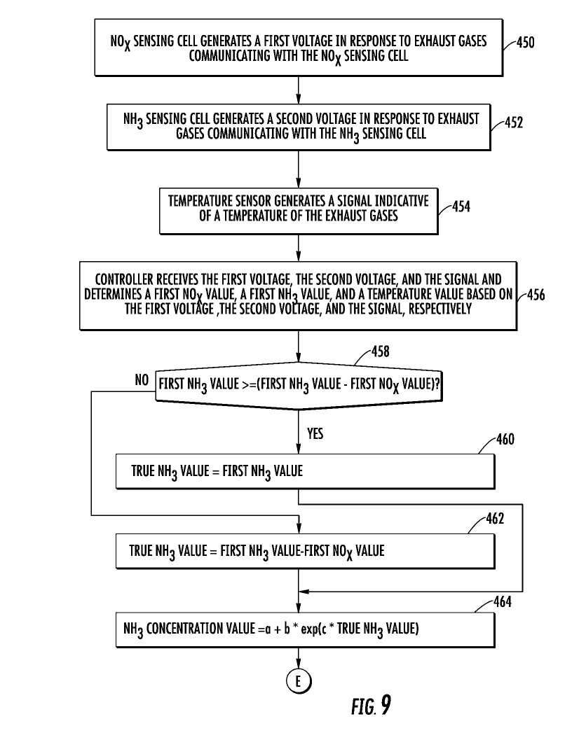

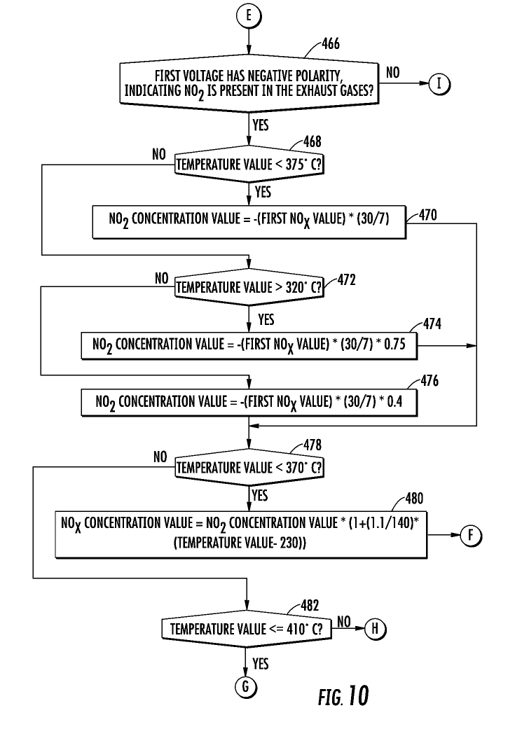

Referring to FIG. 6, a graph 210 having curves 212, 214, 216 is illustrated. The curve 212 corresponds to an exemplary signal from the temperature sensor 34 indicating temperatures of exhaust gases flowing through the exhaust pipe 22 over a first time interval. The curve 214 corresponds to an exemplary signal from the NOₓ sensing cell 60 indicating NOₓ concentrations of exhaust gases flowing through the exhaust pipe 26 over the first time interval. The curve 216 corresponds to an exhaust flow rate through the exhaust pipes 22, 26, 30 over the first time interval.

Referring to FIG. 7, a graph 230 having curves 232, 234, 236, 238 is illustrated. The curve 232 illustrates NOₓ concentrations in the exhaust pipe 26 determined by a laboratory monitoring system over a first time interval. The curve 236 illustrates NOₓ concentrations in the exhaust pipe 26 determined by the exhaust gas sensing system 33 over the first time interval. As shown, the curve 236 has a high degree of correlation to the curve 232, indicating that the system 33 is accurately determining NOₓ concentrations over the first time interval. The curve 234 illustrates NO₂ concentrations in the exhaust pipe 26 determined by a laboratory monitoring system over the first time interval. The curve 238 illustrates NO₂ concentrations in the exhaust pipe 26 determined by the exhaust gas sensing system 33 over the first time interval. As shown, the curve 238 has a high degree of correlation to the curve 234, indicating that the system 33 is accurately determining NO₂ concentrations over the first time interval.

Referring again to FIG. 1, the NH₃/NOₓ sensor 38 is provided to generate a voltage indicative of a NOₓ concentration in exhaust gases downstream of the combined diesel particulate filter and SCR catalyst 28. It should also be noted that the NH₃/NOₓ sensor 38 also generates a voltage indicative of a NH₃ concentration in exhaust gases downstream of the combined diesel particulate filter and SCR catalyst 28. The NH₃/NOₓ sensor 38 includes a NOₓ sensing cell 360, a NH₃ sensing cell 362, insulating layers 364, 366, 368, 370, 372, 374, an electrolyte layer 376, an active layer 378, a current collector 380, electrical leads 381, 382, 384, 386, 387, contact pads 400, 402, 404, electrodes 406, 408, and a contact pad 437.

The NOₓ sensing cell 360 is provided to generate a voltage indicative of a NOₓ concentration in exhaust gases communicating with the NOₓ sensing cell 360. The NOₓ sensing cell 360 includes a NOₓ sensing electrode 410, a reference electrode 412, and the electrolyte layer 376. The NOₓ sensing electrode 400 is disposed on the top surface of the insulating layer 364 and is electrically coupled via the electrical lead 382 to the contact pad 400. The electrolyte layer 376 is disposed between a bottom surface of the insulating layer 364 and a top surface of the insulating layer 366. The reference electrode 412 is disposed on a top surface of the insulating layer 366, which is disposed adjacent a bottom surface of the electrolyte layer 376. The reference electrode 412 is electrically coupled via the electrical lead 384 to the contact pad 402. The general function of the NOₓ sensing electrode 360 includes NOₓ sensing capability (e.g., catalyzing NOₓ gas to produce an emf), electrical conducting capability (conducting electrical current produced by the emf), and gas diffusion capability (providing sufficient open porosity so that gas can diffuse throughout the electrode and to the interface region of the electrode and electrolyte). The NOₓ sensing electrode 360 can be constructed from oxides of ytterbium, chromium, europium, erbium, zinc, neodymium, iron, magnesium, gadolinium, terbium, chromium, as well as combinations comprising at least one of the foregoing, such as YbCrO₃, LaCrO₃, ErCrO₃, EuCrO₃, SmCrO₃, HoCrO₃, GdCrO₃, NdCrO₃, TbCrO₃, ZnFe₂O₄, MgFe₂O₄, and ZnCr₂O₄, as well as combinations comprising at least one of the foregoing. Further, the NOx sensing electrode 110 can comprise dopants that enhance the material(s)' NOx sensitivity and selectivity and electrical conductivity at the operating temperature. These dopants can include one or more of the following elements: Ba (barium), Ti (titanium), Ta (tantalum), K (potassium), Ca (calcium), Sr (strontium), V (vanadium), Ag (silver), Cd (cadmium), Pb (lead), W (tungsten), Sn (tin), Sm (samarium), Eu (europium), Er (Erbium), Mn (manganese), Ni (nickel), Zn (zinc), Na (sodium), Zr (zirconium), Nb (niobium), Co (cobalt), Mg (magnesium), Rh (rhodium), Nd (neodymium), Gd (gadolinium), and Ho (holmium), as well as combinations comprising at least one of the foregoing dopants.

The NH₃ sensing cell 362 is provided to generate a voltage indicative of a NH₃ concentration in exhaust gases communicating with the NH₃ sensing cell 362. The NH₃ sensing cell 362 includes a NH₃ electrode 420, the reference electrode 412, and the electrolyte layer 376. The NH₃ electrode 420 is disposed on a current collector 380 which is further disposed on the portion of the top surface of the insulating layer 364. The NH₃ electrode 420 is electrically coupled via the electrical lead 382 the contact pad 404. The general function of the NH₃ sensing electrode 362 includes NH₃ sensing capability (e.g., catalyzing NH₃ gas to produce an electromotive force (emf)), electrical conducting capability (conducting electrical current produced by the emf), and gas diffusion capability (providing sufficient open porosity so that gas can diffuse throughout the electrode and to the interface region of the NH₃ sensing electrode 362 and the layer 376). The NH₃ sensing electrode 362 can be constructed from first oxide compounds of vanadium (V), tungsten (W), and molybdenum (Mo), as well as combinations comprising at least one of the foregoing, which can be doped with second oxide components, which can increase the electrical conductivity or enhance the NH₃ sensing sensitivity and/or NH₃ sensing selectivity to the first oxide components. Exemplary first components include the ternary vanadate compounds such as bismuth vanadium oxide (BiVO₄), copper vanadium oxide (Cu₂(VO₃)₂), ternary oxides of tungsten, and/or ternary molybdenum (MoO₃), as well as combinations comprising at least one of the foregoing. Exemplary second component metals include oxides such as alkali oxides, alkali earth oxides, transition metal oxides, rare earth oxides, and oxides such as SiO₂, ZnO, SnO, PbO, TiO₂, In₂O₃, Ga₂O₃, Al₂O₃, GeO, and Bi₂O₃, as well as combinations comprising at least one of the foregoing. The NH₃ electrode material can also include traditional oxide electrolyte materials such as zirconia, doped zirconia, ceria, doped ceria, or SiO₂, Al₂O₃ and the like, e.g., to form porosity and increase the contact area between the NH₃ electrode material and the electrolyte. Additives of low soft point glass frit materials can be added to the electrode materials as binders to bind the electrode materials to the surface of the electrolyte. Further examples of NH₃ sensing electrode materials can be found in U.S. patent Ser. No. 10/734,018, to Wang et al., and commonly assigned herewith.

The insulating layer 366 is disposed between the electrolyte layer 376 and the active layer 378. The insulating layer 366 includes an inlet 430 extending therethrough for communicating exhaust gases to the reference electrode 412. The insulating layer 366 can be constructed from a dielectric material such as alumina.

The active layer 378 is disposed between the insulating layer 366 and the insulating layer 368. The electrode 408 is disposed on the top surface of the active layer 378 and is disposed adjacent an inlet 432 extending through the active layer 378. The inlet 432 is in fluid communication with the inlet 430 in the insulating layer 366. The electrode 408 is electrically coupled to an electrical lead 386 which is further electrically coupled to the contact pad 402. The active layer 78 can be constructed from a dielectric material such as alumina.

The insulating layer 368 is disposed between the active layer 378 and the insulating layer 370. The insulating layer 368 can be constructed from a dielectric material such as alumina. The insulating layer 368 has an inlet 434 extending therethrough that is in fluid communication with the inlet 432 of the active layer 378. The electrode 406 is disposed on a top surface of the insulating layer 368 and is electrically coupled via the electrical lead 387 to the contact pad 437. The electrode 406 generates a signal (T) indicative of a temperature of exhaust gases communicating with the NH₃/NOₓ sensor 38 that is received by the controller 40.

The insulating layer 370 is disposed between the insulating layer 368 and the insulating layer 372. The insulating layer 370 can be constructed from a dielectric material such as alumina.

The insulating layer 372 is disposed between the insulating layer 368 and the insulating layer 374. The insulating layers 372 and 374 can be constructed from dielectric materials such as alumina.

The contact pads 400, 402, 404 are disposed on the top surface of the insulating layer 364. A voltage between the contact pads 400, 402 is indicative of a NOₓ concentration in exhaust gases communicating with the sensor 336. A voltage between the contact pads 404 and 402 is indicative of a NH₃ concentration in exhaust gases communicating with the sensor 336.

Referring to FIGS. 3-5, a flowchart of a method for sensing exhaust gas constituents utilizing the exhaust gas sensing system 33 will now be explained.

At step 450, the NOₓ sensing cell 360 generates a first voltage in response to exhaust gases communicating with the NOₓ sensing cell 360.

At step 452, the NH₃ sensing cell 362 generates a second voltage in response to exhaust gases communicating with the NH₃ sensing cell 362.

At step 454, the temperature sensor 34 generates a signal indicative of a temperature of the exhaust gases.

At step 456, the controller 40 receives the first voltage, the second voltage, and the signal and determines a first NOₓ value, a first NH₃ value, and a temperature value based on the first voltage, the second voltage, and the signal, respectively.

At step 458, the controller 40 makes a determination as to whether the first NH₃ value is greater than or equal to (first NH₃ value−first NOₓ value). If the value of step 458 equals “yes”, the method advances to step 460. Otherwise, the method advances to step 462.

At step 460, the controller 40 calculates a true NH₃ value utilizing the following equation: true NH₃ value=first NH₃ value. After step 460, the method advances to step 464.

At step 462, the controller 40 calculates a true NH₃ value utilizing the following equation: true NH₃ value=first NH₃ value−first NOₓ value. After step 462, the method advances to step 464.

At step 464, the controller 40 calculates a NH₃ concentration value utilizing the following equation: NH₃ concentration value=a+b*exp(c*true NH₃ value), where a, b, c are predetermined constant values. After step 464, the method advances to step 466.

At step 466, the controller 40 makes a determination as to whether the first voltage has a negative polarity, indicating NO₂ is present in the exhaust gases. If the value of step 466 equals “yes”, the method advances to step 468. Otherwise, the method advances to step 490.

At step 468, the controller 40 makes a determination as to whether the temperature value is less than 375° C. If the value of step 468 equals “yes”, the method advances to step 470. Otherwise, the method advances to step 472.

At step 470, the controller 40 calculates a NO₂ concentration value utilizing the following equation: NO₂ concentration value=−(first NOₓ value)*(30/7). After step 470, the method advances to step 478.

At step 472, the controller 40 makes a determination as to whether the temperature value is greater than 320° C. If the value of step 472 equals “yes”, the method advances to step 474. Otherwise, the method advances to step 476.

At step 474, the controller 40 calculates the NO₂ concentration value utilizing the following equation: NO₂ concentration value=−(first NOₓ value)*(30/7)*0.75. After step 474, the method advances to step 478.

At step 476, the controller 40 calculates the NO₂ concentration value utilizing the following equation: NO₂ concentration value=−(first NOₓ value)*(30/7)*0.4. After step 476, the method advances to step 478.

At step 478, the controller 40 makes a determination as to whether the temperature value is less than 370° C. If the value of step 478 equals “yes”, the method advances to step 480. Otherwise, the method advances to step 482.

At step 480, the controller 40 calculates the NOₓ concentration value utilizing the following equation: NOₓ concentration value=NO₂ concentration value*(1+(1.1/140)*(temperature value−230)). After step 480, the method advances to step 488.

At step 482, the controller 40 makes a determination as to whether the temperature value is less than or equal to 410° C. If the value of step 482 equals “yes”, the method advances to step 484. Otherwise, the method advances to step 486.

At step 484, the controller 40 calculates the NOₓ concentration value utilizing the following equation: NOₓ concentration value=NO₂ concentration value*(2.1+(0.52/40)*(temperature value−370))). After step 484, the method advances to step 488.

At step 486, the controller 40 calculates the NOₓ concentration value utilizing the following equation: NOₓ concentration value=NO₂ concentration value*((2.62+(2.47/95)*(temperature value−410)))). After step 486, the method advances to the step 488.

At step 488, the controller 40 calculates a NO concentration value utilizing in the following equation: NO concentration value=NOₓ concentration value−NO₂ concentration value. After step 488, the method advances to step 490.

At step 490, the controller 40 makes a determination as to whether the first voltage has positive polarity, indicating NO₂ is not present in the exhaust gases. If the value of step 490 equals “yes”, the method advances to step 492. Otherwise, the method advances to step 498.

At step 492, the controller 40 calculates the NO₂ concentration value utilizing the following equation: NO₂ concentration value=0. After step 492, the method advances to step 494.

At step 494, the controller 40 calculates the NO concentration value utilizing the following equation: NO concentration value=10^{(first NOx value/A)}. After step 494, the method advances to step 496.

At step 496, the controller 40 calculates the NOₓ concentration value utilizing the following equation: NOₓ concentration value=NO concentration value.

At step 498, the controller 40 stores the NO concentration value, NO₂ concentration value, the NOₓ concentration value, and the NH₃ concentration value in the memory device 41.

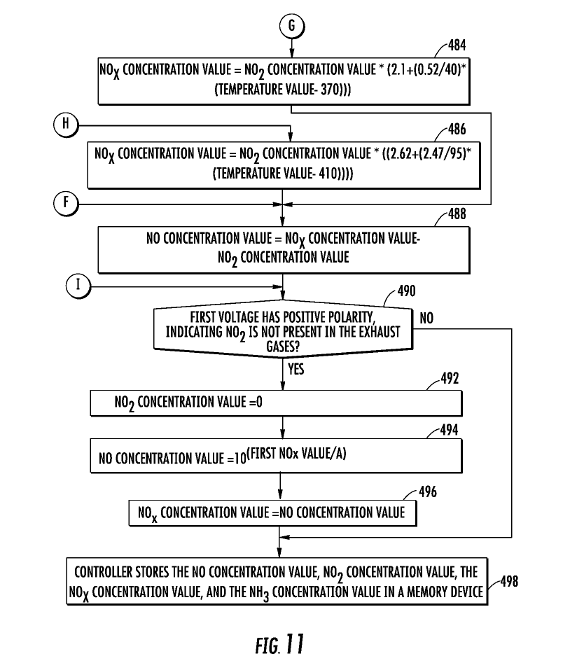

Referring to FIG. 12, a graph 510 having curves 522, 524, 526, 528 is illustrated. The curve 522 corresponds to an exemplary signal from the temperature sensor 34 indicating temperatures of exhaust gases flowing through the exhaust pipe 22 over a second time interval. The curve 524 corresponds to an exemplary signal from the NOₓ sensing cell 360 indicating NOₓ concentrations in exhaust gases flowing through the exhaust pipe 30 over the second time interval. The curve 526 corresponds to an exemplary signal from the NH₃ sensing cell 362 indicating NH₃ concentrations in exhaust gases flowing through the exhaust pipe 30 over the second time interval.

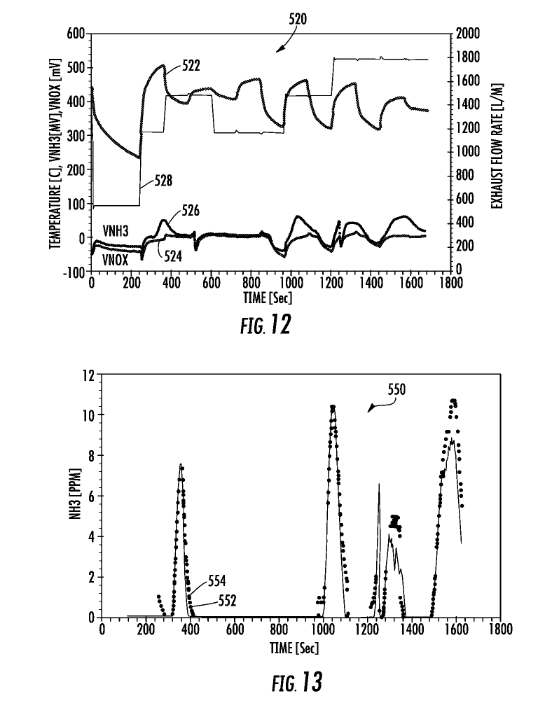

Referring to FIG. 13, a graph 550 having curves 552 and 554 is illustrated. The curve 552 illustrates NH₃ concentrations in the exhaust pipe 30 determined by a laboratory monitoring system over the second time interval. The curve 554 illustrates NH₃ concentrations in the exhaust pipe 30 determined by the exhaust gas sensing system 33 over the second time interval. As shown, the curve 554 has a high degree of correlation to the curve 552, indicating that the system 33 is accurately determining NH₃ concentrations over the second time interval.

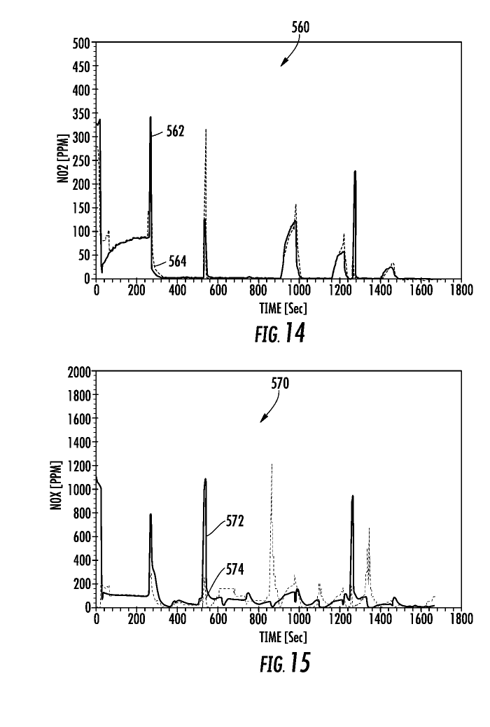

Referring to FIG. 14, a graph 560 having curves 562 and 564 is illustrated. The curve 562 illustrates NO₂ concentrations in the exhaust pipe 30 determined by a laboratory monitoring system over the second time interval. The curve 564 illustrates NO₂ concentrations in the exhaust pipe 30 determined by the exhaust gas sensing system 33 over the second time interval. As shown, the curve 564 has a high degree of correlation to the curve 562, indicating that the system 33 is accurately determining NO₂ concentrations over the second time interval.

Referring to FIG. 15, a graph 570 having curves 572 and 574 is illustrated. The curve 572 illustrates NO concentrations in the exhaust pipe 30 determined by a laboratory monitoring system over the second time interval. The curve 574 illustrates NO concentrations in the exhaust pipe 30 determined by the exhaust gas sensing system 33 over the second time interval.

The exhaust gas sensing system and methods for determining exhaust gas constituents provide a substantial advantage over other systems and methods. In particular, the exhaust gas sensing system and methods provide a technical effect of accurately determining NOₓ, NO₂, NOₓ and NH₃ concentrations in exhaust gases.

While embodiments of the invention are described with reference to the exemplary embodiments, it will be understood by those skilled in the art that various changes may be made and equivalents may be substituted for elements thereof without departing from the scope of the invention. In addition, many modifications may be made to the teachings of the invention to adapt to a particular situation without departing from the scope thereof. Therefore, it is intended that the invention not be limited to the embodiment disclosed for carrying out this invention, but that the invention includes all embodiments falling within the scope of the intended claims. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

What is claimed is:

1. An exhaust gas sensing system, comprising:
a NOₓ sensing cell configured to generate a voltage in response to exhaust gases communicating with the NOₓ sensing cell;
a temperature sensor configured to generate a signal indicative of a temperature of the exhaust gases; and
a controller configured to receive the voltage from the NOₓ sensing cell and to determine a first NOₓ value based on the voltage, the controller further configured to receive the signal from the temperature sensor and to determine a temperature value based on the signal, the controller further configured to determine a NO₂ concentration value indicative of an amount of NO₂ in the exhaust gases based on the first NOₓ value and the temperature value, and to store the NO₂ concentration value in a memory device, the controller further configured to determine a NOₓ concentration value indicative of an amount of NOₓ in the exhaust gases based on the NO₂ concentration value and the temperature value, and to store the NOₓ concentration value in the memory device.

2. The exhaust gas sensing system of claim 1, wherein the controller is further configured to determine an NO concentration value indicative of an amount of NO in the exhaust gases based on the NO₂ concentration value and the NOₓ concentration value and to store the NO concentration value in the memory device.

3. The exhaust gas sensing system of claim 1, wherein the controller is configured to determine the NO₂ concentration value when the voltage from the NOₓ sensing cell has a negative polarity.

4. A method for sensing exhaust gas constituents in exhaust gases, utilizing an exhaust gas sensing system, the system having a NOₓ sensing cell, a temperature sensor, and a controller, the method comprising:
generating a voltage in response to the exhaust gases communicating with the NOₓ sensing cell, utilizing the NOₓ sensing cell;
generating a signal indicative of a temperature of the exhaust gases, utilizing a temperature sensor; and
determining a first NOₓ value based on the voltage, utilizing the controller;
determining a temperature value based on the signal, utilizing the controller;
determining a NO₂ concentration value indicative of an amount of NO₂ in the exhaust gases based on the first NOₓ value and the temperature value, and storing the NO₂ concentration value in a memory device, utilizing the controller; and
determining a NOₓ concentration value indicative of an amount of NOₓ in the exhaust gases based on the NO₂ concentration value and the temperature value, and storing the NOₓ concentration value in the memory device, utilizing the controller.

5. An exhaust gas sensing system, comprising:
a NOₓ sensing cell configured to generate a voltage in response to exhaust gases communicating with the NOₓ sensing cell;
a temperature sensor configured to generate a signal indicative of a temperature of the exhaust gases; and
a controller configured to receive the voltage from the NOₓ sensing cell and to determine a first NOₓ value based on the voltage, the controller further configured to receive the signal from the temperature sensor and to determine a temperature value based on the signal, the controller further configured to determine an NO concentration value indicative of an amount of NO in the exhaust gases based on the first NOₓ value and a constant value, and to store the NO concentration value in a memory device, the controller further configured to set a NOₓ concentration value indicative of an amount of NOₓ in the exhaust gases equal to the NO concentration value, and to store the NOₓ concentration value in the memory device.

6. The exhaust gas sensing system of claim 5, wherein the controller is further configured to set an NO₂ concentration value indicative of an amount of NO₂ in the exhaust gases equal to zero, and to store the NO₂ concentration value in the memory device.

7. The exhaust gas sensing system of claim 5, wherein the controller is configured to determine the NO concentration value when the voltage from the NOₓ sensing cell has a positive polarity.

8. A method for sensing exhaust gas constituents in exhaust gases, utilizing an exhaust gas sensing system, the system having a NOₓ sensing cell, a temperature sensor, and a controller, the method comprising:
generating a voltage in response to the exhaust gases communicating with the NOₓ sensing cell, utilizing the NOₓ sensing cell;
generating a signal indicative of a temperature of the exhaust gases, utilizing a temperature sensor; and
determining a first NOₓ value based on the voltage, utilizing the controller;
determining a temperature value based on the signal, utilizing the controller;
determining an NO concentration value indicative of an amount of NO in the exhaust gases based on the first NOₓ value and a constant value, and storing the NO concentration value in a memory device, utilizing the controller; and
determining a NOₓ concentration value indicative of an amount of NOₓ in the exhaust gases equal to the NO concentration value, and storing the NOₓ concentration value in the memory device, utilizing the controller.

9. An exhaust gas sensing system, comprising:
a NOₓ sensing cell configured to generate a first voltage in response to exhaust gases communicating with the NOₓ sensing cell;
a NH₃ sensing cell configured to generate a second voltage in response to the exhaust gases communicating with the NH₃ sensing cell;
a temperature sensor configured to generate a signal indicative of a temperature of the exhaust gases; and
a controller configured to receive the first voltage from the NOₓ sensing cell and to determine a first NOₓ value based on the first voltage, the controller further configured to receive the second voltage from the NH₃ sensing cell and to determine a first NH₃ value based on the second voltage, the controller further configured to receive the signal and to determine a temperature value based on the signal, the controller further configured to determine an NH₃ concentration value based on the first NOₓ value and the first NH₃ value, the controller further configured to determine a NO₂ concentration value indicative of an amount of NO₂ in the exhaust gases based on the first NOₓ value, the NH₃ concentration value, and the temperature value, and to store the NO₂ concentration value in a memory device, the controller further configured to determine a NOₓ concentration value based on the NO₂ concentration value and the temperature value, and to store the NOₓ concentration value in the memory device.

10. The exhaust gas sensing system of claim 9, wherein the controller is further configured to determine an NO concentration value indicative of an amount of NO in the exhaust gases based on the NO₂ concentration value and the temperature value and to store the NO concentration value in the memory device.

11. The exhaust gas sensing system of claim 9, wherein the controller is configured to determine the NO₂ concentration value when the voltage from the NOₓ sensing cell has a negative polarity.

12. A method for sensing exhaust gas constituents in exhaust gases, utilizing an exhaust gas sensing system, the system having a NOₓ sensing cell, a NH₃ sensing cell, a temperature sensor, and a controller, the method comprising:
generating a first voltage in response to exhaust gases communicating with the NOₓ sensing cell, utilizing the NOₓ sensing cell;
generating a second voltage in response to the exhaust gases communicating with the NH₃ sensing cell, utilizing the NH₃ sensing cell;
generating a signal indicative of a temperature of the exhaust gases, utilizing the temperature sensor;
determining a first NOₓ value based on the first voltage, utilizing the controller;
determining a first NH₃ value based on the second voltage, utilizing the controller;
determining a temperature value based on the signal, utilizing the controller;
determining an NH₃ concentration value based on the first NOₓ value and the first NH₃ value, utilizing the controller;
determining a NO₂ concentration value indicative of an amount of NO₂ in the exhaust gases based on the first NOₓ value, the NH₃ concentration value, and the temperature value, and storing the NO₂ concentration value in a memory device, utilizing the controller; and
determining a NOₓ concentration value based on the NO₂ concentration value and the temperature value, and storing the NOₓ concentration value in the memory device, utilizing the controller.
